(19) United States
(12) Patent Application Publication
(10) Pub. No.: US 2021/0053187 A1
(43) Pub. Date: Feb. 25, 2021

(54) PARTICLE BLAST APPARATUS

(71) Applicant: Cold Jet, LLC, Loveland, OH (US)

(72) Inventors: Richard Broecker, Loveland, OH (US); Daniel Mallaley, Loveland, OH (US); Richard Moore, Loveland, OH (US)

(21) Appl. No.: 16/999,633

(22) Filed: Aug. 21, 2020

Related U.S. Application Data
(60) Provisional application No. 62/890,044, filed on Aug. 21, 2019.

(51) Int. Cl. B24C 7/00; B24C 1/08; B24C 5/02

(52) U.S. Cl. CPC B24C 7/0023; B24C 5/02; B24C 1/08

(57) ABSTRACT

A particle blast apparatus or system entrains blast media particles from a particle source into a transport fluid which already has blast media particles entrained therein. The system may have, prior thereto, entrained blast media particles into the transport fluid which at that time did not already have blast media particles entrained therein. The particle types may be dissimilar, such as dry ice particles and abrasive media particles.

### TECHNICAL FIELD

The present invention relates to methods and apparatuses which entrain blast media particles in a flow, and is particularly directed to methods and apparatuses for entraining particles from more than one source into a single flow.

### BACKGROUND

Particle blast systems utilizing various types of blast media are well known. Systems for entraining cryogenic particles, such as solid carbon dioxide particles, in a transport fluid and for directing the entrained particles toward objects/targets are well known, as are the various component parts associated therewith, such as nozzles, and are shown in U.S. Pat. Nos. 4,744,181, 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,524,172, 6,695,679, 6,695,685, 6,726,549, 6,739,529, 6,824,450, 7,112,120, 7,950,984, 8,187,057, 8,277,288, 8,869,551, 9,095,956, 9,592,586, 9,931,639 and 10,315,862 all of which are incorporated herein in their entirety by reference.

Additionally, U.S. patent application Ser. No. 11/853,194, filed Sep. 11, 2007, for Particle Blast System With Synchronized Feeder and Particle Generator; U.S. Patent Provisional Application Ser. No. 61/589,551 filed Jan. 23, 2012, for Method And Apparatus For Sizing Carbon Dioxide Particles; U.S. Patent Provisional Application Ser. No. 61/592,313 filed Jan. 30, 2012, for Method And Apparatus For Dispensing Carbon Dioxide Particles; U.S. patent application Ser. No. 13/475,454, filed May 18, 2012, for Method And Apparatus For Forming Carbon Dioxide Pellets; U.S. patent application Ser. No. 14/062,118 filed Oct. 24, 2013 for Apparatus Including At Least An Impeller Or Diverter And For Dispensing Carbon Dioxide Particles And Method Of Use US Pub. No. 2014/0110510; U.S. patent application Ser. No. 14/516,125, filed Oct. 16, 2014, for Method And Apparatus For Forming Solid Carbon Dioxide US Pub. No. 2015/0166350; U.S. patent application Ser. No. 14/849,819, filed Sep. 10, 2015, for Apparatus And Method For High Flow Particle Blasting Without Particle Storage US Pub. No. 2015/0375365; U.S. patent application Ser. No. 15/297,967, filed Oct. 19, 2016, for Blast Media Comminutor US Pub. No. 2017/0106500; and U.S. patent application Ser. No. 15/961,321, filed Apr. 24, 2018 for Particle Blast Apparatus, are all incorporated herein in their entirety by reference.

Also well known are particle blast apparatuses which entrain non-cryogenic blast media, such as but not limited to abrasive blast media. Examples of abrasive blast media include, without limitation, silicon carbide, aluminum oxide, glass beads, crushed class and plastic. Abrasive blast media can be more aggressive than dry ice media, and its use preferable in some situations.

Mixed media blasting is also known, in which more than one type of media is entrained within a flow which is directed toward a target. In one form of mixed media blasting, dry ice particles and abrasive media are entrained in a single flow and directed toward a target.

### BRIEF DESCRIPTION OF THE DRAWINGS

The accompanying drawings illustrate embodiments which serve to explain the principles of the present innovation.

FIG. 1 diagrammatically illustrates an apparatus configured in accordance with one or more teachings of this disclosure.

FIG. 2 diagrammatically illustrates the apparatus of FIG. 1.

FIG. 3A is a diagrammatic cross-sectional view of an exemplary metering valve, with the plunger completely occluding the metering orifice.

FIG. 3B is a view of the sleeve of FIG. 6 in situ, showing the metering orifice fully occluded by the plunger.

FIG. 4A is a diagrammatic cross-sectional view similar to FIG. 3A, with the plunger partially occluding the metering orifice.

FIG. 4B is a view of the sleeve of FIG. 6 similar to FIG. 3B, showing the metering orifice partially occluded by the plunger.

FIG. 5A is a diagrammatic cross-sectional view similar to FIG. 3A, with the plunger partially occluding the metering orifice to a lesser amount than as illustrated in FIG. 4A.

FIG. 5B is a view of the sleeve of FIG. 6 similar to FIG. 3B, showing the metering orifice partially occluded by the plunger to a lesser amount than as illustrated in FIG. 4B.

FIG. 6 is a diagrammatic perspective view of the sleeve depicted in FIGS. 3A, 3b, 4A, 4B, 5A and 5B.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, one or more embodiments constructed according to the teachings of the present innovation are described.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference.

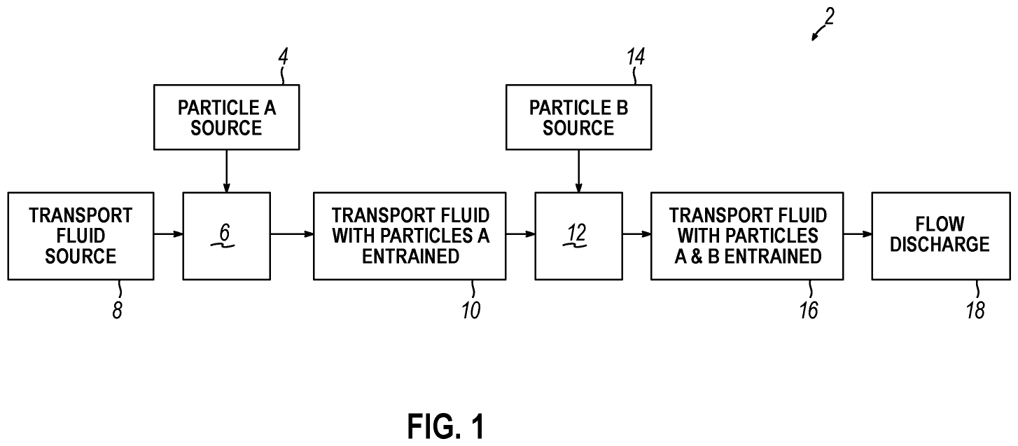

FIG. 1 diagrammatically illustrates particle blast apparatus or system, generally indicated at 2. Particles of type A (referred to herein nonlimitingly for clarity as particles A) from particle A source 4 and are entrained at a first location by feeder 6 in moving transport fluid from transport fluid source 8. Thus, feeder 6 introduces particles of type A into the moving transport fluid. Feeder 6 may also meter particles A as they are entrained into the moving transport fluid, establishing the flow rate of particles A (which may be described in weight per unit time) relative to the moving flow of transport fluid. Thus feeder 6 may also be referred to as meter 6 or metering element. Transport fluid with particles A entrained 10 exits feeder 6, and the entrained flow is directed into feeder 12. Particles of type B (referred to herein nonlimitingly for clarity as particles B) from particle B source 14 are entrained at a second location by feeder 12 in the flow of transport fluid with particles A entrained. Thus, feeder 12 introduces particles of type B into the flow of transport fluid that has particles A entrained therein. Feeder 12 may also meter particles B as they are entrained into the flow of transport fluid entrained with particles A, establishing the flow rate of particles B (which may be described in weight per unit time) relative to the flow of transport fluid entrained with particles A. Thus feeder 12 may also be referred to as meter 12 or metering element 12. Transport fluid with particles A and B entrained 16 exits feeder 12, and the transport fluid with particles A and B entrained is directed to flow discharge 18 at a third location, where the flow exits particle blast system 2 to an ultimate use such as being directed against a target, such as a workpiece.

Particle A source 4 may be any suitable source, such as a holding or storage device, for example a hopper. If particles A can be created, such as dry ice pellets, particle A source 4 may be a continuous distribution device, for example a device in which particles flow upon creation directly and continuously with substantially no storage of the particles to feeder 6. Similarly, particle B source 14 may be any suitable source, such as a holding or storage device, for example a hopper. Similarly, if particles B can be created, particle B source 14 may be a continuous distribution device. Particles A and B may be any suitable types of particles, and may be identical types of particles.

In one embodiment, particles A and B are different types of particles. An embodiment in which particles A are dry ice particles and particles B are abrasive media particles will be described in detail, but the present invention is not limited thereto in types of particles, nor in the order of particles (which type is particle A and which type is particle B), nor to dissimilar particle types.

Transport fluid from transport fluid source 8 may be any suitable transport fluid, such as air, at any suitable pressure, such as 40 psig up to 300 psig. As indicated above, transport fluid flow, at least after it leaves transport fluid source 8, is flowing fluid which has sufficient kinetic energy to convey particles entrained therein through/along the passageways of particle blast system 2, to accelerate the entrained particles through a blast nozzle and discharge the particles from the blast nozzle.

A method which may be practiced by the use of particle blast apparatus 2 comprises entraining particles, which are not already entrained in a transport fluid, into a transport fluid which has particles already entrained therein. More specifically, for particle A type being dry ice particles and particle B type being abrasive blast media, the method practiced by particle blast apparatus 2 comprises entraining abrasive media from a source of abrasive media into the transport fluid with dry ice particles entrained therein.

Another method which may be practiced by the use of particle blast apparatus 2 comprises entraining first particles, which are not entrained in transport fluid, into transport fluid which does not have particles already entrained therein, and subsequently entraining second particles into the transport fluid that has the first particles entrained therein. More specifically, for particle A type being dry ice particles and particle B type being abrasive blast media, the method practiced by particle blast system 2 comprises entraining dry ice particles from a source of dry ice particles into transport fluid that does not have particles already entrained therein, and subsequently entraining abrasive media particles from a source of abrasive media into the transport fluid with dry ice particles entrained therein.

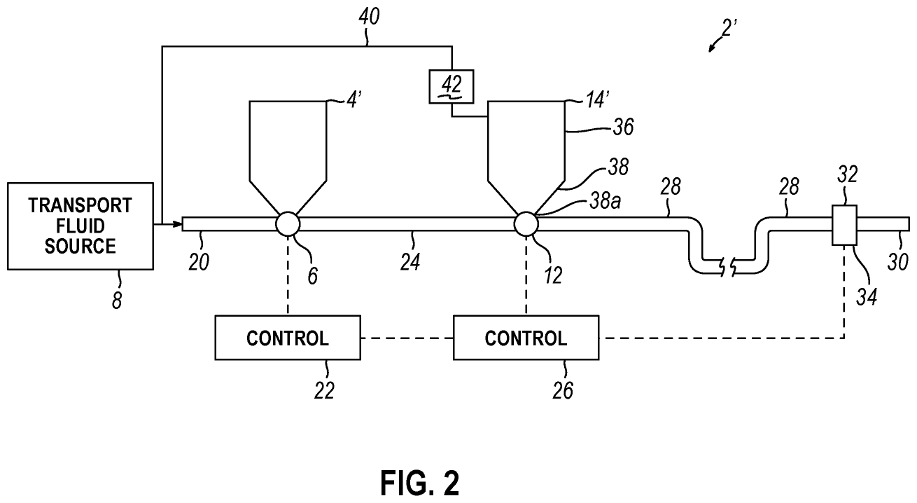

Referring to FIG. 2, the apparatus of FIG. 1 is again illustrated using different diagrammatic representations. FIG. 2 depicts an embodiment of particle blast apparatus, generally indicated at 2′, in which particle A source may be a hopper, indicated at 4′, such as any of the configurations of the disclosures incorporated herein by reference, such as used for dry ice particles. Feeder 6 may be any suitable feeder configuration, such as a rotor with pockets, which is configured to entrain particles from hopper 4′ into the transport fluid. Transport fluid flows through passageway 20 of particle blast apparatus 2′ into feeder 6. A pressure regulator (not shown) may be disposed between transport fluid source 8 and feeder 6. Feeder 6 entrains particles A into the transport fluid. In the embodiment depicted, feeder 6 meters particles A at a rate that may be set by controller 22. Controller 22 may be configured to control the operation of feeder 6. Transport fluid with particles A entrained therein flows through passageway 24 of particle blast system 2′ to feeder 12. Feeder 12 receives particles B from particle B source 14′, and entrains them in the transport fluid flowing from passageway 24. In the embodiment depicted, feeder 12 meters particles B at a rate that may be set by controller 26. In one embodiment, controller 20 and controller 26 may communication with each other to coordinate the simultaneous control of particle blast system 2′. In another embodiment, controller 20 and controller 26 may be a single controller controlling both feeder 6 and feeder 12, or may be separate logical controllers of a single controller.

Transport fluid with particles A and particles B entrained therein flow from feeder 12 through passageway 28, depicted as a delivery hose, to blast nozzle 30. Blast nozzle 30 may be of any suitable configuration, and in the embodiment depicted is configured to accelerate the transport fluid with the entrained particles A and B. Blast nozzle 30 may be configured as a supersonic nozzle. Blast nozzle 30 may be mounted to applicator 32 which may be configured to receive a plurality of different nozzles, one at a time. The embodiment depicted includes trigger 34 which may be used to actuate the flow of transport fluid and feeders 6 and 12. Controllers 22 and 26, whether configured as one controller or separate controllers, may be configured to set and control all aspects of the operation of particle blast apparatus 2′.

Particle B source 14′ may be configured to be a source of abrasive blast media. As is known for abrasive blast media, particle B source 14′ may be configured to be pressurized, and comprise upper, cylindrical portion 36 and lower frustroconical portion 38, which define interior 44 which may be pressurized. The fluid for pressurizing interior 44 may come from transport fluid source 8, via pressure line 40. Pressure regulator 42 may be included to regulate the pressure within interior 44. As is known for abrasive blast media blasting apparatuses, feeder 12 may be configured as a metering valve for controlling the amount of abrasive blast media that is entrained by meter 12 into the transport fluid.

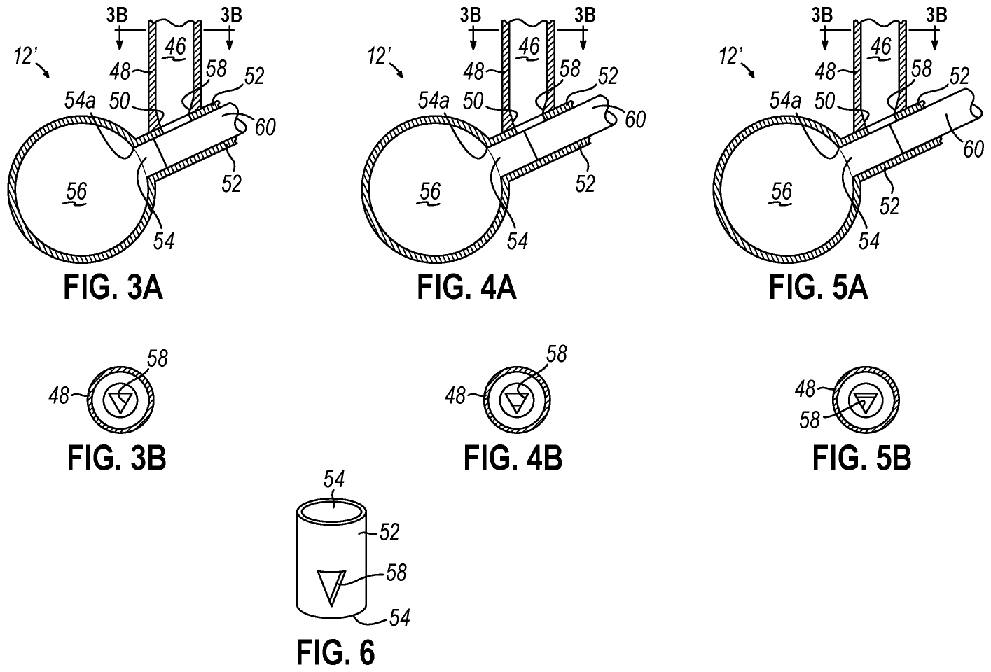

Meter 12 may be of any suitable configuration of metering valve suitable for the type of abrasive blast media being used. Referring to FIGS. 3A, 4A and 5A, there is diagrammatically and embodiment of a modified version of a known metering valve 12′. In an embodiment utilizing metering valve 12′, metering valve 12′ is disposed at and connected to lower end 38a of lower frustroconical portion 38. In the embodiment depicted, metering valve 12′ includes passageway 46, defined by housing 48, which is in fluid communication with interior 44. In the embodiment depicted, passageway 46 includes opening 50 at its lower end, adjacent sleeve 52. (Since these figures are diagrammatic, the additional structure which supports and locates the features described is not illustrated.) Sleeve 52 defines passageway 54 which may also be referred to as bore 54 which is in fluid communication with passageway 56 at end 54a. The transport fluid flows through metering valve 12′ through passageway 56.

Referring also to FIG. 6, sleeve 52 includes metering orifice 58 formed through its wall. Metering orifice 58 is configured with a circumferential dimension that increases axially in the direction moving away from end 54a.

Metering valve 12′ includes plunger 60, which is axially reciprocable within bore 54. In the embodiment depicted, the axial position of plunger 60 effects the metering function of metering valve 12′. The axial position of plunger 60 may be controlled automatically to vary and set the flow rate of the abrasive blast media through metering valve 12′.

As seen in FIGS. 3A and 3B, plunger 60 is disposed in a position such that metering orifice 58 is completely occluded by plunger 60. In this position, passageway 46 is not in fluid communication with passageway 56, so that no abrasive blast media can flow from interior 44 to passageway 56.

Referring to FIGS. 4A and 4B, plunger 60 is disposed in a position such that metering orifice 58 is partially occluded, placing passageway in fluid communication with passageway 56 thereby allowing abrasive blast media to flow from interior 44 to passageway 56.

Referring to FIGS. 5A and 5B, plunger 60 is disposed in a position such that metering orifice 58 is still partially occluded, but less so than illustrated in FIGS. 4A and 4B, placing passageway in fluid communication with passageway 56 thereby allowing abrasive blast media to flow from interior 44 to passageway 56. In this position, the flow rate of abrasive blast media into passageway 56 will be higher than the flow rate for the position of plunger 60 illustrated in FIGS. 4A and 4B.

The increasing circumferential width of metering orifice 58 affects the change in abrasive blast media flow rate into passageway 56 based on the position of plunger 60. Metering orifice 58 may have other suitable shapes, although the shape depicted provides excellent control over the flow rate of the abrasive blast media, particularly at low flow rates.

The pressure within interior 44 is set to have a higher static pressure than the static pressure of passageway 56 proximal or adjacent end 54a, so as to provide a desired static pressure differential between interior 44 and passageway 56. It has been observed in an embodiment that too low of a pressure differential, such as 2 PSI and lower, may result in inadequate flow of abrasive blast media into passageway 56 where the abrasive blast media is entrained in the transport fluid. It has also been observed in an embodiment that too high of a pressure differential, such as 8 PSI and higher, may result in less control of the flow rate for the various positions of plungers 60. It has been observed in an embodiment that a static pressure differential in the range of 4 PSI to 5 PSI produces a desirable, controllable flow rate.

### Example 1

A method of entraining a plurality of particles into a flow of transport fluid for directing toward a target, comprising the steps of: introducing at a first location particles of a first plurality of particles into a flow of transport fluid thereby creating an entrained flow comprising the particles of the first plurality of particles entrained in the flow of transport fluid; directing the entrained flow to a second location; and introducing at the second location particles of a second plurality of particles into the entrained flow thereby creating an entrained flow comprising the particles of the first and second pluralities of particles entrained in the flow of transport fluid.

### Example 2

The method of example 1, comprising directing the entrained flow from second location to a flow discharge at a third location.

### Example 3

The method of example 1, wherein the first plurality of particles are of a first type of media and the second particles are of a second type of media and the first type is the same as the second type.

### Example 4

The method of example 1, wherein the first plurality of particles are of a first type of media and the second particles are of a second type of media and the first type is different from the second type.

### Example 5

The method of example 4, wherein the first type is carbon dioxide media and the second type is abrasive media.

### Example 6

The method of example 1, wherein the flow rate of the particles of the first plurality of particles relative to the flow of the transport fluid is controlled at the first location.

### Example 7

The method of example 1, wherein the flow rate of the particles of the second plurality of particles relative to the flow of the transport fluid is controlled at the second location.

### Example 8

A method of entraining a plurality of particles into a flow of transport fluid for directing toward a target, comprising the step of introducing a first plurality of particles which are not already entrained in a transport fluid flow into a moving flow comprising a second plurality particles entrained in a flow of transport fluid.

### Example 9

The method of example 8, wherein the first plurality of particles are of a first type of media and the second particles are of a second type of media and the first type is different from the second type.

### Example 10

A particle blast system comprising: a source of transport fluid; a first source of blast media, the blast media comprising a plurality of particles of a first type; a first metering element disposed at a first location and configured to introduce particles from the first source of blast media into a flow of transport fluid from the source of transport fluid so as to entrain the particles into the flow of transport fluid; a second source of blast media, the blast media comprising a plurality of particles of a second type; and a second metering element disposed at a second location, the second metering element configured to receive particles from the second source which are not entrained in a flow of transport fluid and to introduce the particles from the second source into the flow of transport fluid which has the particles of the first type entrained therein.

### Example 11

The particle blast system of example 10 wherein the second source of blast media is pressurized.

### Example 12

The particle blast system of example 11, wherein the second source of blast media is pressurized by the transport fluid via a pressure line.

### Example 13

The particle blast system of example 12, comprising a pressure regulator disposed in the pressure line.

### Example 14

The particle blast system of example 10, wherein the first metering element is configured to introduce cryogenic particles into the flow of transport fluid from the source of transport fluid.

### Example 15

The particle blast system of example 10, wherein the second metering element is configured to introduce abrasive media particles into the flow of transport fluid which has the particles of the first type entrained therein.

### Example 16

The particle blast system of example 10, comprising a first fluid passageway in fluid communication with the first location and the second location and through which flows the flow of transport fluid which has the particles of the first type entrained therein and wherein the second metering element comprises: a second passageway in fluid communication with the first fluid passageway; and a metered orifice in fluid communication with the second source of blast media and in fluid communication with the second passageway, the metered orifice configured to control the rate of flow of particles from the second source of blast media.

### Example 17

The particle blast system of example 16, wherein the metered orifice comprises a plunger which is moveable along an axis from and including a first position at which the metered orifice is completely occluded and a second position at which the metered orifice is not completely occluded.

### Example 18

The particle blast system of example 17, wherein the metered orifice has a first end adjacent the first position and has width which increases in the axial direction from the first end toward the second position.

In accordance with various aspects of the disclosure, an element, or any portion of an element, or any combination of elements may be implemented with a “processing system” that includes one or more physical devices comprising processors. Non-limiting examples of processors include microprocessors, microcontrollers, digital signal processors (DSPs), field programmable gate arrays (FPGAs), programmable logic devices (PLDs), programmable logic controllers (PLCs), state machines, gated logic, discrete hardware circuits, and other suitable hardware configured to perform the various functionality described throughout this disclosure. One or more processors in the processing system may execute processor-executable instructions. A processing system that executions instructions to effect a result is a processing system which is configured to perform tasks causing the result, such as by providing instructions to one or more components of the processing system which would cause those components to perform acts which, either on their own or in combination with other acts performed by other components of the processing system would cause the result. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. Computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Explicit Definitions

“Based on” means that something is determined at least in part by the thing that it is indicated as being “based on.” When something is completely determined by a thing, it will be described as being “based exclusively on” the thing.

“Processor” means devices which can be configured to perform the various functionality set forth in this disclosure, either individually or in combination with other devices. Examples of “processors” include microprocessors, microcontrollers, digital signal processors (DSPs), field programmable gate arrays (FPGAs), programmable logic devices (PLDs), programmable logic controllers (PLCs), state machines, gated logic, and discrete hardware circuits. The phrase “processing system” is used to refer to one or more processors, which may be included in a single device, or distributed among multiple physical devices.

“Instructions” means data which can be used to specify physical or logical operations which can be performed by a processor. Instructions should be interpreted broadly to include, code, code segments, program code, programs, subprograms, software modules, applications, software applications, software packages, routines, subroutines, objects, executables, threads of execution, procedures, functions, hardware description language, middleware, etc., whether encoded in software, firmware, hardware, microcode, or otherwise.

A statement that a processing system is “configured” to perform one or more acts means that the processing system includes data (which may include instructions) which can be used in performing the specific acts the processing system is “configured” to do. For example, in the case of a computer (a type of “processing system”) installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

The foregoing description of one or more embodiments of the innovation has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the innovation and its practical application to thereby enable one of ordinary skill in the art to best utilize the innovation in various embodiments and with various modifications as are suited to the particular use contemplated. Although only a limited number of embodiments of the innovation is explained in detail, it is to be understood that the innovation is not limited in its scope to the details of construction and arrangement of components set forth in the preceding description or illustrated in the drawings. The innovation is capable of other embodiments and of being practiced or carried out in various ways. Also specific terminology was used for the sake of clarity. It is to be understood that each specific term includes all technical equivalents which operate in a similar manner to accomplish a similar purpose. It is intended that the scope of the invention be defined by the claims submitted herewith.

1. A method of entraining a plurality of particles into a flow of transport fluid for directing toward a target, comprising the steps of:
a. introducing at a first location particles of a first plurality of particles into a flow of transport fluid thereby creating an entrained flow comprising the particles of the first plurality of particles entrained in the flow of transport fluid;
b. directing the entrained flow to a second location; and
c. introducing at the second location particles of a second plurality of particles into the entrained flow thereby creating an entrained flow comprising the particles of the first and second pluralities of particles entrained in the flow of transport fluid.

2. The method of claim 1, comprising directing the entrained flow from second location to a flow discharge at a third location.

3. The method of claim 1, wherein the first plurality of particles are of a first type of media and the second particles are of a second type of media and the first type is the same as the second type.

4. The method of claim 1, wherein the first plurality of particles are of a first type of media and the second particles are of a second type of media and the first type is different from the second type.

5. The method of claim 4, wherein the first type is carbon dioxide media and the second type is abrasive media.

6. The method of claim 1, wherein the flow rate of the particles of the first plurality of particles relative to the flow of the transport fluid is controlled at the first location.

7. The method of claim 1, wherein the flow rate of the particles of the second plurality of particles relative to the flow of the transport fluid is controlled at the second location.

8. A method of entraining a plurality of particles into a flow of transport fluid for directing toward a target, comprising the step of introducing a first plurality of particles which are not already entrained in a transport fluid flow into a moving flow comprising a second plurality particles entrained in a flow of transport fluid.

9. The method of claim 8, wherein the first plurality of particles are of a first type of media and the second particles are of a second type of media and the first type is different from the second type.

10. A particle blast system comprising:
a. a source of transport fluid
b. a first source of blast media, the blast media comprising a plurality of particles of a first type;
c. a first metering element disposed at a first location and configured to introduce particles from the first source of blast media into a flow of transport fluid from the source of transport fluid so as to entrain the particles into the flow of transport fluid;
d. a second source of blast media, the blast media comprising a plurality of particles of a second type; and
e. a second metering element disposed at a second location, the second metering element configured to receive particles from the second source which are not entrained in a flow of transport fluid and to introduce the particles from the second source into the flow of transport fluid which has the particles of the first type entrained therein.

11. The particle blast system of claim 10 wherein the second source of blast media is pressurized.

12. The particle blast system of claim 11, wherein the second source of blast media is pressurized by the transport fluid via a pressure line.

13. The particle blast system of claim 12, comprising a pressure regulator disposed in the pressure line.

14. The particle blast system of claim 10, wherein the first metering element is configured to introduce cryogenic particles into the flow of transport fluid from the source of transport fluid.

15. The particle blast system of claim 10, wherein the second metering element is configured to introduce abrasive media particles into the flow of transport fluid which has the particles of the first type entrained therein.

16. The particle blast system of claim 10, comprising a first fluid passageway in fluid communication with the first location and the second location and through which flows the flow of transport fluid which has the particles of the first type entrained therein and wherein the second metering element comprises:
a. a second passageway in fluid communication with the first fluid passageway; and
b. a metered orifice in fluid communication with the second source of blast media and in fluid communication with the second passageway, the metered orifice configured to control the rate of flow of particles from the second source of blast media.

17. The particle blast system of claim 16, wherein the metered orifice comprises a plunger which is moveable along an axis from and including a first position at which the metered orifice is completely occluded and a second position at which the metered orifice is not completely occluded.

18. The particle blast system of claim 17, wherein the metered orifice has a first end adjacent the first position and has width which increases in the axial direction from the first end toward the second position.
